(19) United States
(12) Patent Application Publication
(10) Pub. No.: US 2017/0103046 A1
(43) Pub. Date: Apr. 13, 2017

(54) SYSTEM AND METHOD FOR PROVIDING PERSONALIZED FONT VIA PROCESSOR-BASED APPLICATION

(71) Applicant: Holden Schroder, Topanga, CA (US)

(72) Inventor: Holden Schroder, Topanga, CA (US)

(21) Appl. No.: 15/277,685

(22) Filed: Sep. 27, 2016

Related U.S. Application Data
(60) Provisional application No. 62/238,462, filed on Oct. 7, 2015.

(51) Int. Cl. G06F 17/21; G06F 3/0488

(52) U.S. Cl. CPC G06F 17/214; G06F 3/04883

(57) ABSTRACT

A personalized font development system for use by a user within a processor-based device includes a capturing means, an isolating means, a mapping means, and a font atlas. The capturing means captures one or more handwritten text characters with the device. The isolating means isolates at least one font character from the one or more handwritten text characters to be included in a personalized font. The mapping means enables the user to select a mapping character to be associated with each font character. The font character(s) and the associated mapping character for each font character are saved in the font atlas. The handwritten text character(s) can be provided by the user within a handwritten document or by drawing the one or more handwritten text characters on a display screen.

### RELATED APPLICATION

This application claims priority on U.S. Provisional Application Ser. No. 62/238,462, filed on Oct. 7, 2015 and entitled “SYSTEM AND METHOD FOR PROVIDING PERSONALIZED FONT VIA PROCESSOR-BASED APPLICATION”. As far as permitted, the contents of U.S. Provisional Application Ser. No. 62/238,462 are incorporated herein by reference.

### BACKGROUND

We live in an age where technology is moving so fast that it is challenging to keep up with all the changes. We also often hear how much people long for the days when handwritten letters and notes were used to correspond with one another. At the root of this dilemma is the idea that we as people miss the more personal connection and care that is delivered and received with a handwritten message. The unfortunate reality is that those days are unlikely to return. Moreover, standard fonts for texts, emails, etc. such as Times New Roman, Cambria, Arial, and the like, can feel impersonal and downright sterile.

### SUMMARY

The present invention is directed toward a personalized font development system (sometimes referred to herein simply as a “development system”) that enables a user to develop and/or use a personalized font within texts, emails or other printed documents and communications. More particularly, the present invention relates to a system and method for developing a personalized font via a processor-based application within a device such as a smart phone, a computer, etc.

In various embodiments, the personalized font development system includes a capturing means, an isolating means, a mapping means, and a font atlas. The capturing means captures one or more handwritten text characters with the device. The isolating means isolates at least one font character from the one or more handwritten text characters to be included in a personalized font. The mapping means enables the user to select a mapping character to be associated with each of the at least one font character. The at least one font character and the associated mapping character for each font character is saved in the font atlas.

In some embodiments, the one or more handwritten text characters are provided by the user. For example, in one such embodiment, the user can provide a document including the one or more handwritten text characters. In such embodiment, the capturing means can include a camera within the device that captures the one or more handwritten text characters. Additionally, the isolating means can include a device interface that can be manipulated by the user to isolate the at least one font character.

Alternatively, in another such embodiment, the development system can further include a display screen of the device, wherein the user draws the one or more handwritten text characters on the display screen. In such embodiment, the development system further includes motion capturing sensors within the device that capture the one or more handwritten text characters.

In any such embodiment, the development system can further include a touch screen of the device that enables the user to adjust the size of the at least one font character.

Additionally, in some embodiments, the one or more handwritten text characters can include a signature of the user. In some such embodiments, the mapping means can include selecting a single mapping character to be associated with the signature of the user.

Further, the development system can also include a rendering means for rendering a message utilizing the at least one font character and the associated mapping character for each font character that are saved in the font atlas.

Still further, in certain embodiments, the capturing means captures a plurality of handwritten text characters; the isolating means isolates a plurality of font characters from the plurality of handwritten text characters to be included in the personalized font; and the plurality of font characters can be selectively compiled and stored in a single font file. In some such embodiments, the single font file can be exported for use within a third party application. Alternatively, in other such embodiments, the single font file can be offered for sale to one or more consumers.

Additionally, the present invention is also directed toward a method for use by a user in developing a personalized font within a processor-based device, the method including (i) capturing one or more handwritten text characters with the device; (ii) isolating at least one font character from the one or more handwritten text characters to be included in the personalized font; (iii) selecting a mapping character to be associated with each of the at least one font character; and (iv) saving the at least one font character and the associated mapping character for each font character in a font atlas.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of a device including a processor that can be utilized as part of a personalized font development system having features of the present invention;

FIG. 2 is a flowchart that illustrates an embodiment of a method for developing a personalized font using the device in FIG. 1;

FIG. 3A illustrates a representative example of a document with one or more handwritten text characters from which selected font characters can be captured with a camera of the device in FIG. 1;

FIG. 3B illustrates a representative example of an image of the text captured with the camera of the device in FIG. 1;

FIG. 3C illustrates a representative example of selected characters from the handwritten text characters from the image in FIG. 3B that have been isolated by a user;

FIG. 3D illustrates a representative example of a selected word that has been cropped and filtered from the image of the text as illustrated in FIG. 3B;

FIG. 3E illustrates a representative example of a single font character that has been highlighted by the user from the selected word within the image illustrated in FIG. 3B;

FIG. 3F illustrates a representative example of the selected single font character in FIG. 3E overlapping a reference image;

FIG. 3G illustrates a representative example of the selected font character having been sized and positioned in a desirable manner relative to the reference image as shown in FIG. 3F;

FIG. 3H illustrates a representative example of a mapping character that has been selected by the user for associating with the previously selected font character in FIG. 3G;

FIG. 4 is a flowchart that illustrates another embodiment of a method for developing a personalized font using the device in FIG. 1;

FIG. 5 illustrates a representative example of a touch capture screen including a reference image and a handwritten text character that has been drawn on the screen by a finger of the user;

FIG. 6 illustrates a representative example of a custom keyboard that can be utilized for generating and posting a message using the development system in FIG. 1; and

FIG. 7 is a simplified schematic illustration of a plurality of users, a plurality of consumers, and an embodiment of a font store that can be used to store and offer for sale one or more personalized fonts that have been developed within the personalized font development system illustrated in FIG. 1.

### DESCRIPTION

Embodiments of the present invention are described herein in the context of a system and method for providing a personalized font via a processor-based application. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

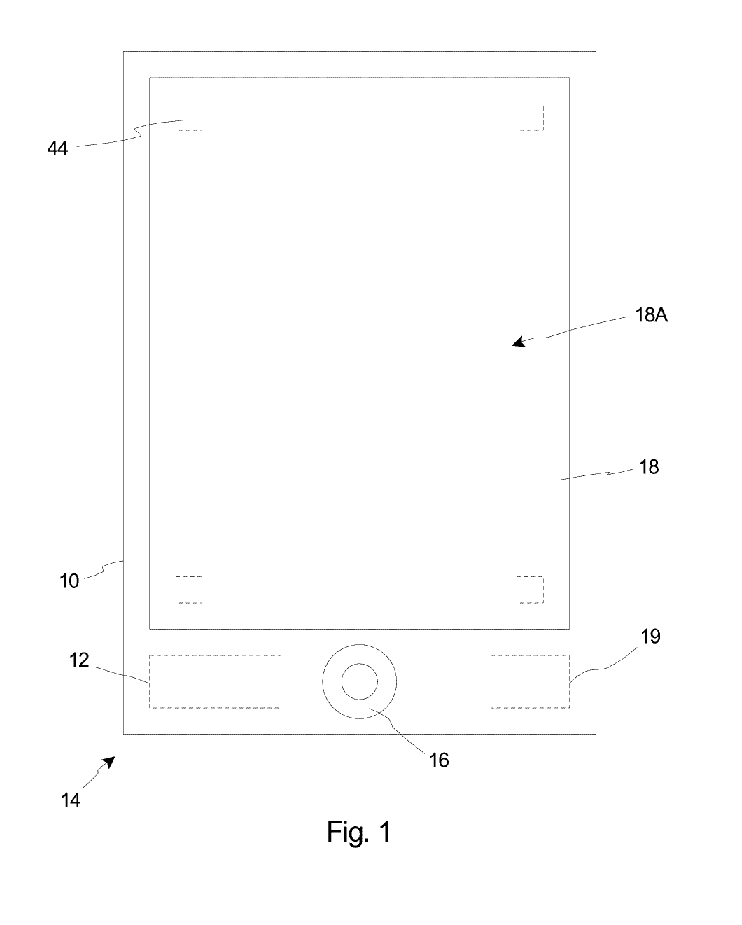

FIG. 1 is a simplified schematic illustration of a device 10, e.g., a smart phone, a computer tablet, or any other computer or other suitable processor-based device. In this embodiment, the device includes a processor 12 (illustrated in phantom) that can be utilized as part of a personalized font development system 14 (also sometimes referred to herein as a “development system” or “app”). More specifically, the development system 14 is an original and innovative application used on the device 10 that personalizes font used for texts, emails, etc. by allowing the consumers to individually create their own personalized font based on their own handwriting, or specifically selected other handwritings. The development system 14 enables the user to capture their writing and then render their captured characters back into messages which they can share to various social networks. Thus, the development system 14 can be utilized to change text messaging and emails forever by giving value back to the individual by empowering their unique script and returning the connection we all miss as human beings.

In certain embodiments, the development system 14 as described herein can be written in any suitable programming language that has the appropriate speed and/or development advantages. However, it should be appreciated that although various aspects of the development system 14 are illustrated and described herein in the context of an operating system for phones (such as an Apple® iPhone®, in one non-exclusive example), the development system 14 can also have capability for other computer and smart phone brands and operating systems.

As shown in FIG. 1, and as described in greater detail herein, the device 10 can include and utilize the processor 12, a camera 16, a display screen 18 and a font atlas 19 (illustrated in phantom) as part of the development system 14. Alternatively, the development system 14 can become operational with more components or fewer components than specifically illustrated and described herein.

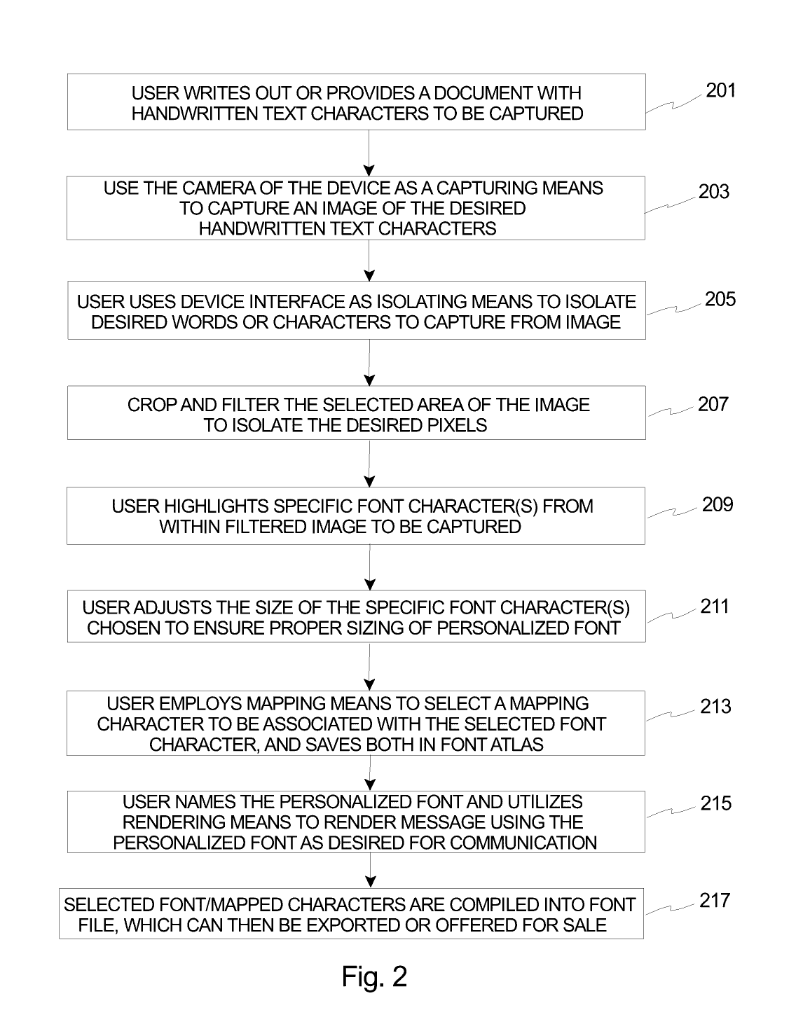

There are various methods by which a user can capture their own handwriting, or specifically selected other handwriting, as part of the development system 14 illustrated and described herein. For example, FIG. 2 is a flowchart that illustrates an embodiment of a method for developing a personalized font using the device 10 illustrated in FIG. 1. This method is sometimes referred to as the “camera capture method”. In particular, as described in detail herein below, this method includes a capturing means that utilizes the camera 16 of the device 10 and recognition software within the processor 12 of the device 10 to capture the desired personalized font. It is recognized that the various steps described herein can be modified as necessary in the process of implementing the development system 14. Additionally, it is also recognized that in certain applications the order of the steps can be modified, certain steps can be omitted, certain steps can be combined, and/or additional steps can be added without limiting the intended scope and breadth of the present invention.

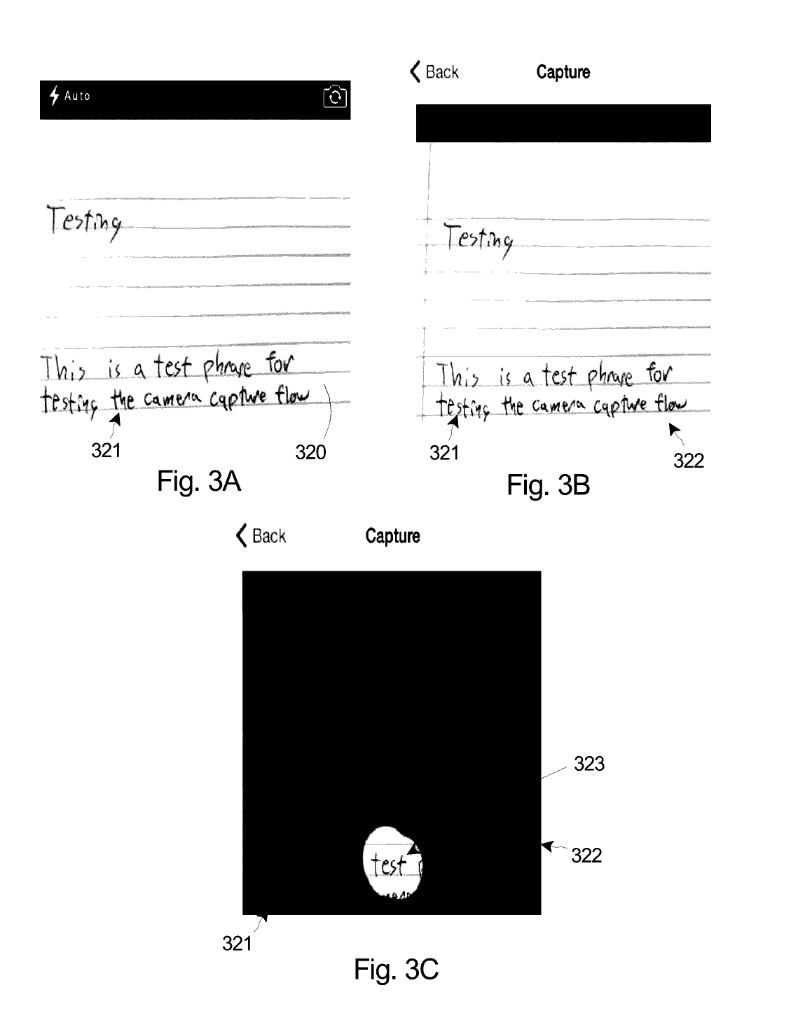

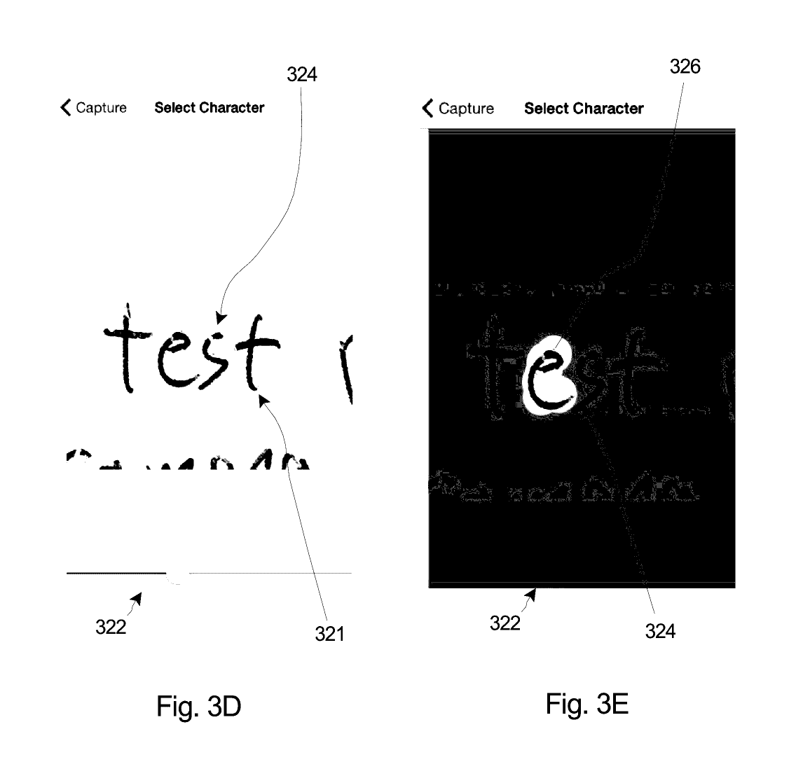

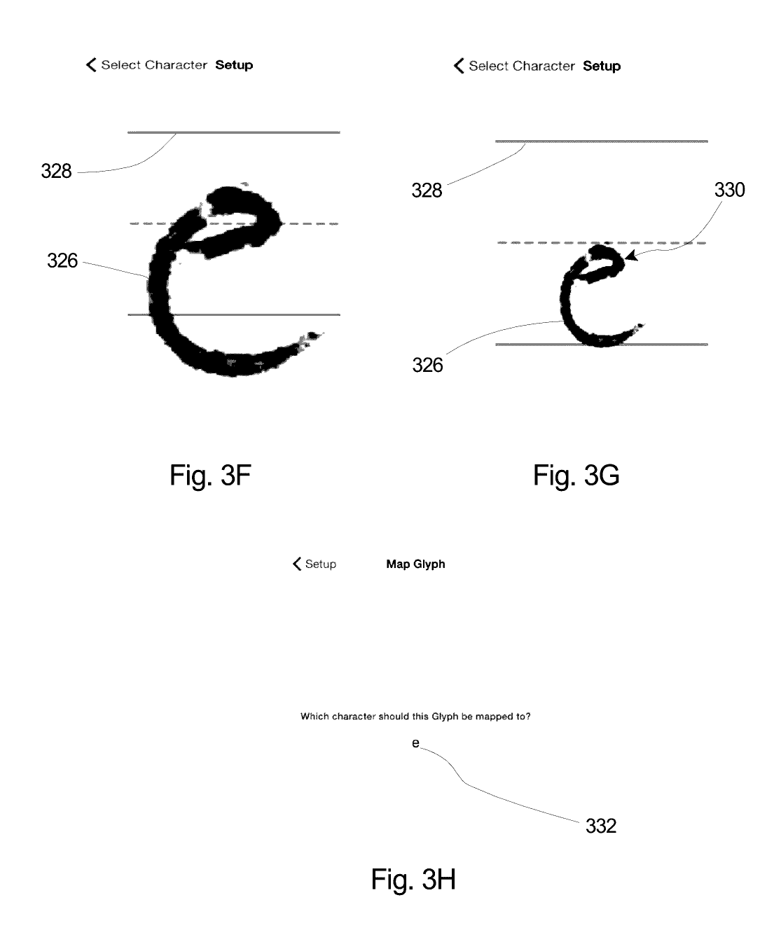

Initially, at step 201, the user writes out or otherwise provides a document 320 (illustrated in FIG. 3A) that includes one or more handwritten text characters 321. For example, the handwritten text characters 321 can include various alphanumeric characters, symbols, punctuation marks, icons, emoticons, emojis, etc. (also sometimes referred to herein generally as “text characters” or simply as “text”) that they want to be captured within the development system 14. Stated in another manner, the user provides one or more handwritten text characters 321 that they want to be captured within the development system 14. In some embodiments, as described in greater detail herein, the alphanumeric characters or text characters can include a signature of the user. FIG. 3A illustrates a representative example of a document 320 with one or more handwritten text characters 321 from which selected font characters can be captured with a camera 16 of the device 10 in FIG. 1.

Next, at step 203, the user uses a capturing means, e.g., the camera 16 of the device 10, to capture an image 322 (illustrated in FIG. 3B) of the desired handwritten text characters 321 that they want to capture, e.g., using a standard image picker interface filtered to a camera source. The capturing means can alternatively include importing an image from another device, or importing an image from a website, database or a different program or application on the device 10 or another device. FIG. 3B illustrates a representative example of an image 322 of the handwritten text characters 321 captured with the camera 16 of the device 10 in FIG. 1. Once the image 322 of the handwritten text characters 321 has been captured, the view can be changed so as to show the image 322 in full color on the display screen 18 (illustrated in FIG. 1).

At step 205, the user can use a touch interface 18A (illustrated in FIG. 1) or device interface within the display screen 18 of the device 10 as an isolating means to isolate the words and/or characters that they want to capture from within the image 322 of the handwritten text characters 321. As such, the words and/or characters that have been so isolated can be referred to as “selected characters”, or “isolated characters”. It is understood that in certain applications, the touch interface 18A in a phone-sized device may limit the ability of the user to precisely isolate individual characters from a full page of text. However, the touch interface 18A utilized to isolate full words from within the text can be fairly simple, merely allowing the user to draw over the word or words that they want to select. Once the user touches the image 322 via the touch interface 18A, the image 322 can be dimmed with the exception of pixels that the user has drawn on. Thus, in on embodiment, a line of pixels can be drawn between the touch updates, with the thickness of the line simulating the radius of the finger point. The user can adjust (or start over) as necessary so that the appropriate and desired text, i.e. the selected characters, has been effectively isolated. FIG. 3C illustrates a representative example of selected characters 323 from the handwritten text characters 321 from the image 322 in FIG. 3B that have been isolated by a user. Once the user is satisfied with what they have selected, they can hit a button to move to the next step.

At step 207, the selected area (or selected characters 323) from within the image 322 selected by the user is cropped and filtered to isolate the desired pixels. Within this step, a boundary can be created that can encapsulate the area that was selected by the user at step 205. The image 322 can then be cropped to what was contained within the boundary. FIG. 3D illustrates a representative example of a selected word 324 that has been cropped and filtered from the image 322 of the handwritten text characters 321 as illustrated in FIG. 3B.

In some embodiments, pixels that were not directly under the drawn selection are not culled at this point due to concerns about user precision control at this point in the process. The image 322 is then filtered to isolate a best guess as to what specific pixels represent the word, words and/or characters that the user in interested in capturing. In one non-exclusive embodiment, the filtering process takes advantage of a CIKernel custom filter technology, which allows the developer to write a custom image filter in a language similar to pixel shader languages like HLSL and GLSL, as non-exclusive examples. A specific, non-limiting example of such isolation filter code is provided below:

kernel vec4 isolationFilterKernel(sampler image, _color color, _color
finalColor, float tolerance)
{
vec4 imageColor = sample(image, samplerCoord(image));
vec4 diffVec = color imageColor;
diffVec = abs(diffVec);
float diff = (diffVec.r * 0.299) + (diffVec.g * 0.587) + (diffVec.b *
0.114);
float alpha = compare(tolerance diff,
0.0, 1.0 (
diff / tolerance));
imageColor = vec4(1.0, 1.0, 1.0, 1.0) * (finalColor * alpha);
imageColor.a = alpha;
return imageColor;
}

This filter code shown above is processing the filter color, calculating a luminance value from the RGB components. A tolerance value is passed into the filter kernel and is used to determine if the delta between the target color that is being sought (i.e. black) and the pixel color of the image are within an acceptable range to capture. Since the lighting situation for the image 322 being dealt with by the user may be unknown to the development system 14, the user can be allowed to adjust the tolerance in the touch interface 18A to find a best fit between the target color and the pixel color of the image.

In some embodiments, the color data is not actually written directly from the source image 322 because the capture process may not be refined enough to just capture the ink; it will usually pull in some pixels from the paper itself as well and that could result in some color artifacting at the edges of the characters. Instead, for any pixel that passes the tolerance, the luminance delta is utilized as a multiplier as alpha color to be stored, so that the farther away from the target color the pixel is, the more transparent it is, which blends better with the message background and reduces aliasing.

It should be appreciated that in alternative embodiments, various options may be available for providing handwriting/character recognition software solutions that are equally able to isolate and recognize the selected characters 323.

At step 209, the filtered and cropped image can be displayed on a subsequent screen within the display screen 18 on the device 10, and the user is enabled to highlight a specific section of the image 322 that they want to capture. For example, the user can highlight a specific font character 326 that they want to capture from the selected word 324, and then confirm that their selection is accurate. FIG. 3E illustrates a representative example of a single font character 326 that has been highlighted by the user from the selected word 324 within the image 322 illustrated in FIG. 3B.

At step 211, the user can adjust the size of the selected font character 326 relative to a reference image so that the font character 326 can be appropriately sized within the personalized font. FIG. 3F illustrates a representative example of the selected single font character 326 overlapping a reference image 328. As illustrated, the reference image 328 can be lined to show base and center lines to give the user an idea of sizing and spacing. The user can use pinch gestures to scale the selected font character 326 (or other scaling methods) and they can also move the selected font character 326 up and down relative to the reference image 328 to line the selected font character 326 up with the lines on the reference image 328. FIG. 3G illustrates a representative example of the selected font character 326 having been sized and positioned in a desirable manner relative to the reference image 328. Once the user is satisfied with the position of the selected font character 326, the selected font character 326 can then be formally identified and/or acknowledges as part of a personalized font 330. Subsequently, the user can hit a button to continue.

The scale of the font character 326 is evaluated versus the line positions in the reference image 328 to determine the positioning and the sizing at which the selected font character 326 should be stored. The development system 14 (illustrated in FIG. 1) can also process the pixels of the selected font character 326 to determine where the right and left sides of the font character 326 are located. However, in certain embodiments, it is not necessary to process all of the pixels as pixels below the baseline do not really contribute to the kerning calculations because they can often fall into areas that do not align with the remainder of the selected font character 326. For example, in a lowercase “j”, the hook below the baseline hangs far left of the remainder of the character, and if such spacing is used one may end up with an unnatural amount of space to the left of the “j”. Thus, in such embodiments, no pixels of the selected font character 326 below the baseline are evaluated. Additionally, many uppercase characters often overhang near the top of the character in a way that makes the spacing look unusual if it is used in the kerning calculation. Thus, in such embodiments, only the pixels in the selected font character 326 between the baseline and the center line are evaluated. Once this evaluation is completed, the selected font character data can be moved to and stored within the font atlas 19 within the development system 14.

At step 213, the user can employ a mapping means to select and enter a mapping character that they wish the selected font character 326 to be mapped to. Subsequently, the user can then save the selected font character 326 and the corresponding mapping character in the font atlas 19. FIG. 3H illustrates a representative example of a mapping character 332 that has been selected by the user for associating with the previously selected font character 326 illustrated in FIG. 3G. For example, the selected font character 326 can be mapped to a particular letter, symbol, punctuation mark, etc. as the mapping character 332. Additionally and/or alternatively, in some embodiments, the selected “font character” can encompass a string of characters, such as in a signature of the user. In such embodiments, if desired, the signature of the user can still be represented by a single mapping character 332. For example, in some embodiments, as discussed herein, a special key can be added to a specially designed or custom keyboard, e.g., the custom keyboard 650 illustrated in FIG. 6, that maps directly to the signature of the user.

In one embodiment, the development system 14 only supports single mapping characters 332 for purposes of simplicity. Alternatively, as noted, the development system 14 can be adapted to support mapping to a string of characters, e.g., a text message, a series of emojis or emoticons, or in a user's signature. If the user has already mapped a selected font character 326 to the mapping character 332, the development system 14 can be configured to open a dialog box to ask if the user wants to replace the selected font character 326 that had been previously associated with the mapping character 332. Once it is known which mapping character 332 to associate with the selected font character 326, such mapping connection can be sent to the font atlas 19 along with the sizing, positioning and kerning information that was determined earlier.

Once each selected character has been mapped and saved in the font atlas 19 as desired, at step 215, the user can create a name for the personalized font 330. Then the user can utilize rendering means to render a message, e.g., message 652 illustrated in FIG. 6, using the personalized font 330 as desired. It should be appreciated that the type of message 652 rendered using the personalized font 330 can incorporate any desired type of communication, e.g., text messages, emails, etc.

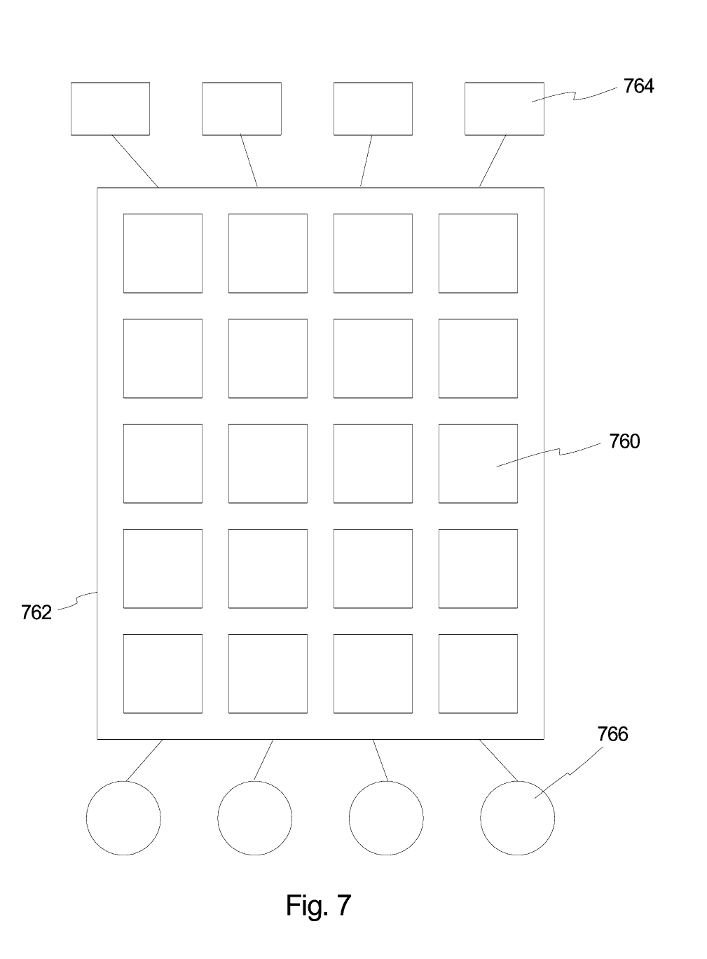

Additionally, at step 217, all of the selected font characters 326 that have been mapped and saved in the font atlas 19 can be compiled into a single font file 760 (illustrated, e.g., in FIG. 7). The font file 760 can then be exported to third party word processing applications that can read and import the font file 760 for use within the given application. Still further and/or alternatively, the font file 760 can be offered for sale to consumers at a font store 762 (illustrated in FIG. 7) or other suitable location, which can be hosted by any suitable party or parties.

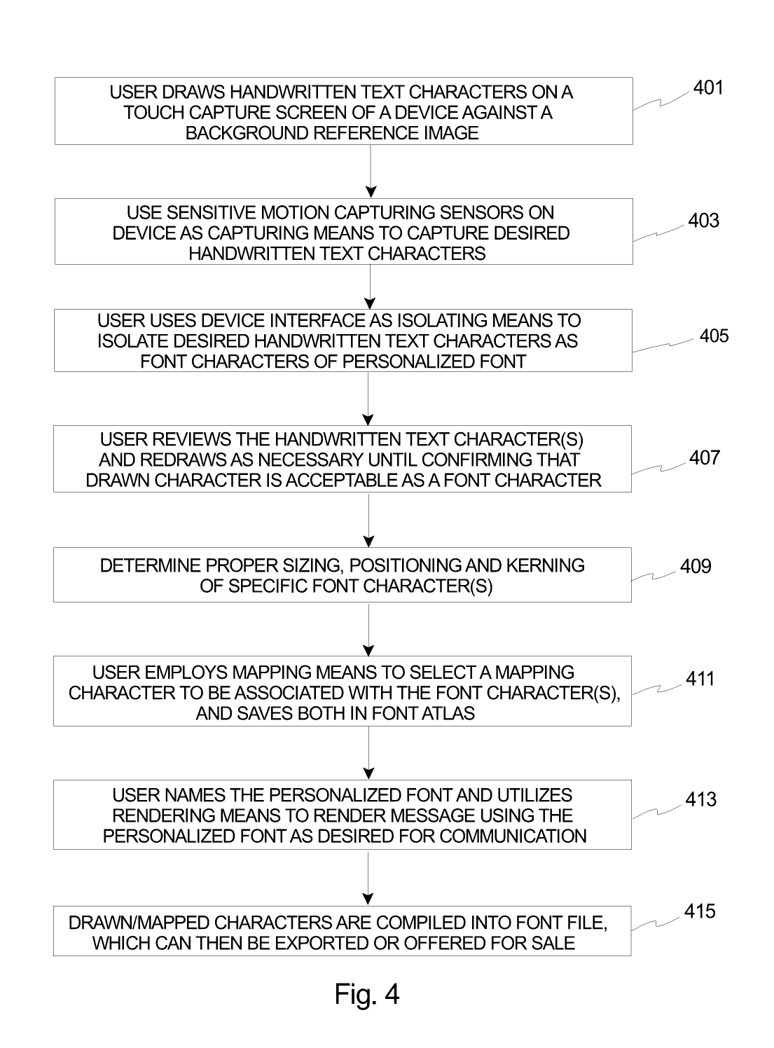

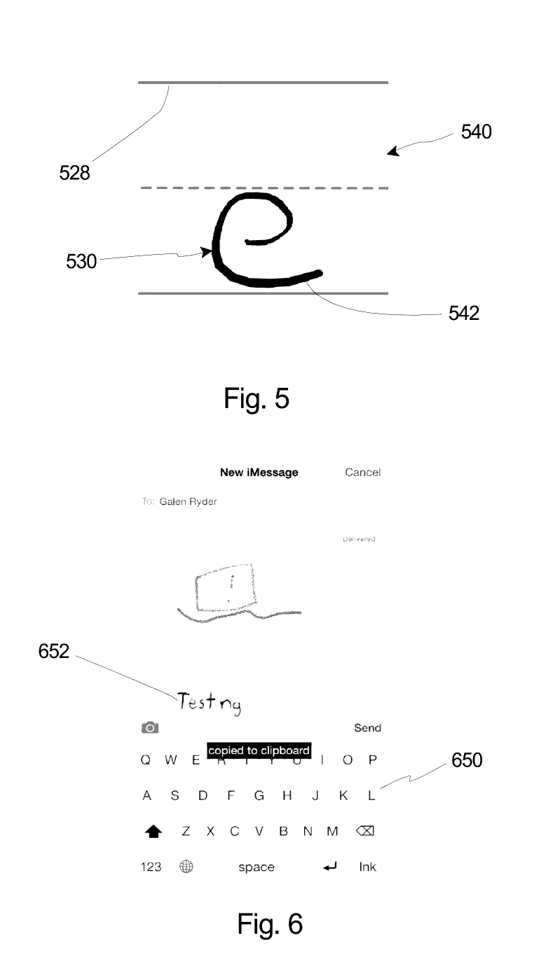

FIG. 4 is a flowchart that illustrates another embodiment of a method for developing a personalized font using the device 10 in FIG. 1. Initially, at step 401, the user draws one or more handwritten text characters on a touch capture screen of a device against a background reference image. FIG. 5 illustrates a representative example of a touch capture screen 540 (or display screen) including a reference image 528 and a handwritten text character 542 that has been drawn on the screen 540 by a finger of the user. In particular, in certain embodiments, the user is provided with a reference image 528, e.g., with center line and baseline, within a touch capture screen 540 or display screen of the device 10 on which to draw the various handwritten text characters 542, e.g., alphanumeric characters, symbols, punctuation marks, icons, emoticons, emojis, etc., that the user wants to utilize within the personalized font 530. It is appreciated that the alphanumeric characters captured with this method can again include the full signature of the user. In various embodiments, the user will use his or her finger to draw the desired handwritten text characters 542, e.g., characters, symbols, punctuation marks, emoticons, icons, emojis, etc. Alternatively, the user can be provided with an implement to do such drawing of the handwritten text characters 542.

At step 403, which can be accomplished substantially simultaneously with step 401, the development system 14 can utilize sensitive motion capturing sensors 44 (illustrated in phantom in FIG. 1) on the device 10 (illustrated in FIG. 1) to capture what is being drawn by the user, i.e. the handwritten text characters 542. In some embodiments, the drawing code emulates some simple functionality from other drawing app operating systems. However, since most devices have no way of determining pressure, the linewidth may be varied based on the speed at which the line is drawn. This can provide a more natural look to the line than may be shown with a more consistent linewidth.

At step 405, the user can use the touch interface 18A (illustrated in FIG. 1) or device interface within the display screen 18 of the device 10 as an isolating means to isolate the words and/or characters that they want to capture from the handwritten text characters 542. As such, the words and/or characters that have been so isolated can be referred to as “selected characters”, “isolated characters” or “font characters” to be utilized within the personalized font 530.

At step 407, the user can review the handwritten text characters 542 to determine if it personally meets their expectations. If the handwritten text character 542 fails to meet the expectations of the user, then the user can redraw the handwritten text character 542 as desired. Otherwise, if the handwritten text character 542 meets the expectations of the user, the user confirms that the handwritten text character 542 is acceptable and can be identified (isolated) as a font character. Stated in another manner, by confirming the acceptability of the handwritten text character 542, the user has isolated the specific handwritten text character 542 as a font character that they wish to be included within their personalized font 530.

Once the font character is confirmed, at step 409, the development system 14 determines the sizing, positioning and kerning of the font character using a process that is substantially similar to what was described herein above in relation to the method illustrated in FIG. 2.

At step 411, similar to the method described in relation to FIG. 2, the user employs a mapping means to select a mapping character (e.g., such as the mapping character 332 illustrated in FIG. 3H) to be associated with the isolated font character 542. The font character 542 and the corresponding mapping character 332 can then be saved in the font atlas 19 (illustrated in FIG. 1). The above steps can be repeated for as many characters, symbols, etc. which the user would like to be included in the personalized font 530.

Once each selected font character 542 has been mapped and saved in the font atlas 19 as desired, at step 413, the user can create a name for the personalized font 530. Then the user can utilize rendering means to render a message, e.g., message 652 illustrated in FIG. 6, using the personalized font 530 as desired. It should be appreciated that the type of message 652 rendered using the personalized font 530 can incorporate any desired type of communication, e.g., text messages, emails, etc.

Additionally, as with the previous method describe in detail above, at step 415, all of the selected font characters 542 that have been mapped and saved in the font atlas 19 can be compiled into a single font file 760 (illustrated, e.g., in FIG. 7). The font file 760 can then be exported to other third party applications that can read and import the font file 760 for use within the given application; and/or the font file 760 can be offered for sale to consumers at a font store 762 (illustrated in FIG. 7) or other suitable location, that can be hosted by any suitable party or parties.

It should be understood that in either method described in detail herein, the user is able to redo, replace and/or erase any handwritten text characters, i.e. alphanumeric characters, symbols, etc. as desired. With such control over the development of the characters and symbols, the methods provided herein clearly demonstrate the ability to create a personalized font. Moreover, it should also be appreciated that any personalized font developed via the methods described herein can be shared with other users as desired. For example, any user who has developed a personalized font can choose to publicize or otherwise share such personalized font, e.g., through various social media channels, such that other users may also be allowed to use such fonts. In different embodiments, the personalized fonts may be shared with other users without compensation to the developer, or the developer of the personalized font may require a fee to enable other users to use their personalized font.

As described herein above, the development system 14 can utilize a font atlas 19 for saving selected and/or drawn font characters, as well as providing the necessary mapping of the font characters so that the font characters are represented as intended by the creator of the personalized font. In one non-exclusive embodiment, the font atlas 19 uses an internal database system to store and save the desired character data. The character images can be stored in cells within a large Atlas Image. The size of the Atlas Image and the size of the cells, and thus the number of characters that can be saved in any given Atlas Image, can be varied depending on memory and quality specifications.

Additionally, in some embodiments, the cells within the font atlas 19 are packed in a common grid formation. The sizing and positioning information are sent to the font atlas 19 along with the character image to determine where to position the font character within the cell. The kerning information is stored in an entry along with the mapping and the position of the font character in the font atlas 19. Kerning and atlas position data is stored in UV space to account for the potential need to resize the atlas image in the future.

Once a collection of font characters and associated mapping characters have been saved in the font atlas 19, as noted above, a user can start to render those characters into messages. The message can be broken down into words and the characters can be drawn by loading up the font atlas 19 and spacing the font characters using the kerning information that was stored. The height of the font characters is determined by a font size setting that the user can tweak as desired. In some embodiments, after each word is written, the development system 14 pre-calculates the size of the next word to determine if the next word can fit on the same line or whether it needs to be started on the next line. Certain applications also support the newline font character so users can determine their own line breaks.

In one non-exclusive embodiment, one way in the development system 14 to render a message is to use the Compose view. The user enters their message into a field and can alter the font size as desired. Once the user is satisfied with the message, the user can hit a button to render their text into a message image. A subsequent screen then allows the user to see the results and post it to any suitable social network or save it to a personal photo album, as non-exclusive examples.

In alternative embodiments, message composition can be generated via a custom keyboard. FIG. 6 illustrates a representative example of a custom keyboard 650 that can be utilized for generating and posting a message 652 using the development system 14 in FIG. 1. The custom keyboard 650 can be usable for entering text into the development system app 14 described herein or into other suitable apps. As noted above, in some embodiments, the custom keyboard 650 can include a single specially created key or button that can be used to add the signature of the user.

Some operating systems have limitations regarding functionality of custom keyboards. Therefore, in certain embodiments, the development system 14 can be modified work around those limitations. For example, images cannot be posted into fields that the custom keyboard 650 is targeting, nor is there any way for certain operating systems to generate a font file that would be usable in certain operating system text fields. To work around this issue, the development system 14 may allow the user enter text into a field and then hit an “Ink” button (for example) on the custom keyboard 650, which grabs the text in the field, generates a message, and then posts the image into a clipboard of the user. The user can then post this image into the field as desired.

Unfortunately, there may be some complications to this technique such as the operating system preventing a keyboard from accessing resources from its container app and accessing the clipboard if the user has not been given permission. So, in such a situation, if the user hits the “Ink” button without the right permissions, the development system 14 can instruct them on how to give the custom keyboard 650 the permissions it needs. The custom keyboard 650 may also have a limited view of the text field, where it simply cannot see all the text. Thus, to combat this issue, the development system 14 has to continue offsetting the field's cursor position until it reaches the end, which is determined by not seeing a change in the visible text after requesting an offset and waiting for a brief period. Once it has been determined that the end of the message has been reached, the development system 14 stores what it sees and erases the text from the field. Such methodology continues, i.e. storing and erasing, until there is no more text.

FIG. 7 is a simplified schematic illustration of a plurality of users 764, a plurality of consumers 766, and an embodiment of a font store 762 that can be used to store and offer for sale one or more personalized fonts that have been developed within the personalized font development system 14 illustrated in FIG. 1.

As utilized herein, the users 764 are the individuals that have created their own personalized fonts within the development system 14, e.g., utilizing either of the methods illustrated and described in detail herein above, or another suitable method. Additionally, each of the users 764 has further compiled all of the font characters and associated mapping characters from their personalized font and saved them in a single font file 760 (illustrated as a box in FIG. 7). The font files 760 are then transferred, e.g., uploaded, to and offered for sale within the font store 762. Thus, the font store 762 can retain and offer for sale a plurality of personalized fonts that are encompassed within the font files 760.

Subsequently, the consumers 766 can access and view some or all of any of the font files 760 in order to determine if they would like to purchase and use the personalized font encompassed within the font file 760. Upon purchase by the consumers 766, the chosen personalized font can then be transferred to, e.g., downloaded by, the consumers 766 for their own personal use as desired.

It is recognized that the font store 762 can be formed in any suitable manner. For example, in some embodiments, the font store 762 can be a data storage cloud that is hosted by a third party that is separate from the users 764 and the consumers 766. In such embodiments, the party hosting the font store 762 and the users 764 who developed the personalized fonts can decide to split or share any revenue gained through sale of the personalized fonts to the consumers 766 in any suitable manner. Alternatively, the font store 762 can be directly hosted by the users 764 themselves. Still alternatively, the font store 762 can be created in another suitable format.

It is understood that although a number of different embodiments of the personalized font development system 14 have been illustrated and described herein, one or more features of any one embodiment can be combined with one or more features of one or more of the other embodiments, provided that such combination satisfies the intent of the present invention.

While a number of exemplary aspects and embodiments of the personalized font development system 14 have been shown and disclosed herein above, those of skill in the art will recognize certain modifications, permutations, additions and sub-combinations thereof. It is therefore intended that the system and method shall be interpreted to include all such modifications, permutations, additions and sub-combinations as are within their true spirit and scope, and no limitations are intended to the details of construction or design herein shown.

What is claimed is:

1. A personalized font development system for use by a user within a processor-based device, the personalized font development system comprising:
capturing means for capturing one or more handwritten text characters with the device;
isolating means for isolating at least one font character from the one or more handwritten text characters to be included in a personalized font;
mapping means for selecting a mapping character to be associated with each of the at least one font character; and
a font atlas wherein the at least one font character and the associated mapping character for each font character is saved in the font atlas.

2. The personalized font development system of claim 1 wherein the one or more handwritten text characters are input by the user.

3. The personalized font development system of claim 2 wherein the user provides a document including the one or more handwritten text characters, and wherein the capturing means includes a camera within the device that captures the one or more handwritten text characters.

4. The personalized font development system of claim 3 wherein the isolating means includes a device interface that can be manipulated by the user to isolate the at least one font character.

5. The personalized font development system of claim 2 further comprising a display screen of the device, wherein the user draws the one or more handwritten text characters on the display screen; and motion capturing sensors within the device that capture the one or more handwritten text characters.

6. The personalized font development system of claim 1 further comprising a touch screen of the device that enables the user to adjust the size of the at least one font character.

7. The personalized font development system of claim 1 wherein the one or more handwritten text characters includes a signature of the user; and wherein the mapping means includes selecting a single mapping character to be associated with the signature of the user.

8. The personalized font development system of claim 1 further comprising a rendering means for rendering a message utilizing the at least one font character and the associated mapping character for each font character that are saved in the font atlas.

9. The personalized font development system of claim 1 wherein the capturing means captures a plurality of handwritten text characters; wherein the isolating means isolates a plurality of font characters from the plurality of handwritten text characters to be included in the personalized font; wherein the plurality of font characters can be selectively compiled and stored in a single font file; and wherein the single font file can be exported for use within a third party application.

10. The personalized font development system of claim 1 wherein the capturing means captures a plurality of handwritten text characters; wherein the isolating means isolates a plurality of font characters from the plurality of handwritten text characters to be included in the personalized font; wherein the plurality of font characters can be selectively compiled and stored in a single font file; and wherein the single font file can be offered for sale to one or more consumers.

11. A method for use by a user in developing a personalized font within a processor-based device, the method comprising:
capturing one or more handwritten text characters with the device;
isolating at least one font character from the one or more handwritten text characters to be included in the personalized font;
selecting a mapping character to be associated with each of the at least one font character; and
saving the at least one font character and the associated mapping character for each font character in a font atlas.

12. The method of claim 11 further comprising the user providing the one or more handwritten text characters.

13. The method of claim 12 wherein the user providing includes the user providing a document including the one or more handwritten text characters; and wherein capturing includes capturing the one or more handwritten text characters with a camera within the device.

14. The method of claim 13 wherein isolating includes isolating the at least one font character using a device interface that can be manipulated by the user.

15. The method of claim 12 wherein the user providing includes the user drawing the one or more handwritten text characters on a display screen of the device; and wherein capturing includes capturing the one or more handwritten text characters with motion capturing sensors within the device.

16. The method of claim 11 further comprising the user adjusting the size of the at least one font character by using a touch screen of the device.

17. The method of claim 11 wherein capturing includes the one or more handwritten text characters including a signature of the user; and wherein selecting includes selecting a single mapping character to be associated with the signature of the user.

18. The method of claim 11 further comprising rendering a message utilizing the at least one font character and the associated mapping character for each font character that are saved in the font atlas.

19. The method of claim 11 wherein capturing includes capturing a plurality of handwritten text characters with the device; and wherein isolating includes isolating a plurality of font characters from the plurality of handwritten text characters to be included in the personalized font; the method further comprising selectively compiling and storing the plurality of font characters in a single font file; and exporting the single font file for use within a third party application.

20. The method of claim 11 wherein capturing includes capturing a plurality of handwritten text characters with the device; and wherein isolating includes isolating a plurality of font characters from the plurality of handwritten text characters to be included in the personalized font; the method further comprising selectively compiling and storing the plurality of font characters in a single font file; and offering the single font file for sale to one or more consumers.
